(19) United States
(12) Patent Application Publication
(10) Pub. No.: US 2010/0189223 A1
(43) Pub. Date: Jul. 29, 2010

(54) DIGITALLY ADDRESSED FLAT PANEL X-RAY SOURCES

(75) Inventors: Mark Eaton, Austin, TX (US); Babu Chalamala, Durham, NC (US); Mitall More, Austin, TX (US)

Correspondence Address: HULSEY IP INTELLECTUAL PROPERTY LAWYERS, P.C., 919 Congress Avenue, Suite 919, AUSTIN, TX, 78701, US

(73) Assignee: Steller Micro Devices

(21) Appl. No.: 12/692,496

(22) Filed: Jan. 22, 2010

Related U.S. Application Data
(63) Continuation-in-part of application No. 12/201,741, filed on Aug. 29, 2008, now abandoned.
Application No. 12/201,741 is a continuation of application No. 11/355,692, filed on Feb. 16, 2006, now abandoned.
(60) Provisional application No. 61/249,087, filed on Oct. 6, 2009.

(51) Int. Cl. G21K 5/04; H05G 1/30; H05G 2/00

(52) U.S. Cl. 378/68; 378/119; 378/91

(57) ABSTRACT

An apparatus and method for the X-ray irradiation of materials is provided. This apparatus includes an irradiation chamber, a number of flat electromagnetic (X-ray) sources having a number of addressable cathode emitters, a support mechanism, a heat transfer system, a shielding system, and a process controller. A shielded portal within the shielding system allows access to an interior volume of the irradiation chamber. The electromagnetic sources are positioned on or embedded within interior surfaces of the irradiation chamber. These electromagnetic sources generate an electromagnetic flux, such as an X-ray flux, where this flux is used to irradiate the interior volume of the irradiation chamber and any materials placed therein. The operation of the electromagnetic sources and the number of addressable cathode emitters being controlled by the process controller. The materials placed within the interior of the chamber may be supported by a low attenuation support mechanism. This low attenuation support mechanism does not substantially reduce the X-ray flux intended to irradiate the materials placed within the interior volume of the irradiation chamber.

### REFERENCES TO RELATED APPLICATIONS

The present U.S. Utility patent application claims priority pursuant to 35 U.S.C. §120, as a continuation-in-part (CIP), to the following U.S. Utility patent application which is hereby incorporated herein by reference in its entirety and made part of the present U.S. Utility patent application for all purposes:

1. U.S. Utility application Ser. No. 12/201,741, entitled “COMPACT RADIATION SOURCE,” (Attorney Docket No. STRY002US1), filed Aug. 29, 2008, pending, which claims priority pursuant to 35 U.S.C. §120 as a continuation to the following U.S. patent application which is hereby incorporated herein by reference in its entirety and made part of the present U.S. Utility patent application for all purposes:

a. U.S. Utility application Ser. No. 11/355,692, entitled “COMPACT RADIATION SOURCE,” (Attorney Docket No. STRY002US0), filed Feb. 16, 2006, abandoned.

The present U.S. Utility patent application also claims priority pursuant to 35 U.S.C. §119(e) to the following U.S. Provisional Patent Application which is hereby incorporated herein by reference in its entirety and made part of the present U.S. Utility patent application for all purposes:

1. U.S. Provisional Application Ser. No. 61/248,987, entitled “DIGITALLY ADDRESSED FLAT PANEL X-RAY SOURCES,” (Attorney Docket No. STRY005US0), filed Oct. 6, 2009, pending.

### STATEMENT REGARDING FEDERALLY FUNDED RESEARCH AND DEVELOPMENT

This invention was made with Government support under Contract No. 70NANB7H7030 awarded by the Advanced Technology Program of the National Institute of Standards and Technology. The U.S. Government has certain rights in the invention.

### TECHNICAL FIELD OF THE INVENTION

The present disclosure relates generally to the assembly and fabrication of a digitally addressed x-ray source, and more particularly, to the construction of a matrix addressable, wide area x-ray sources and their application in digitally addressed x-ray imaging systems.

### BACKGROUND OF THE INVENTION

Since the discovery of X-radiation by Roentgen and others over 100 years ago, X-rays have found widespread use in medical, industrial and scientific imaging as well as in sterilization, lithography, medical radiation therapies and a variety of scientific instruments. X-rays are most commonly produced with vacuum X-rays tubes, the operation of which is shown conceptually in FIG. 1A. An electron beam source, traditionally a single hot filament cathode, is biased at a high potential across a vacuum relative to a metal anode which serves as an X-ray target. Current from the cathode produces both characteristic line radiation and Bremsstrahlung radiation as it strikes the anode target. The target is commonly disposed at an angle to the electron beam current so as to direct the X-rays thus produced out a window located at one side of the tube, this window commonly being made of a material, such as beryllium, with a low atomic number (Z number). As a general matter, the higher the Z number of the target, and the higher the electrical potential and energy of the beam, the more X-radiation is produced. The lower the Z number of the window material, the less radiation is absorbed by the window. Radiation which does not exit the window is absorbed elsewhere in the tube. X-ray flux may be collimated by limiting the flux which exits the tube to a small window surrounded by a higher Z shielding material which absorbs X-rays. The production of X-rays by the electron beam striking the target generates a considerable amount of heat in the small area upon which the single electron beam is incident, with most of the beam energy absorbed in the target. In a typical X-ray tube operating below 200 kV potential between the cathode and anode, less than 2 percent of the electrical power from the cathode is converted to X-ray flux; the rest is converted to heat, which can damage the anode and cause severe thermal stresses in the source. Numerous inventions have been made over the years to conduct this heat out of the tube, to improve the X-ray production efficiency of the target, or to rotate the anode so as to reduce pitting or melting of the target. (J. Selman. The Fundamentals of X-Ray and Radium Physics, 8^{th} ed. Thomas Books: Springfield, Ill. 1994).

Recently, a number systems replace the traditional hot filament cathode in an X-ray tube with a cold cathode operating on the principles of field emission. Field emission cold cathodes have a number of advantages over hot filament cathodes. They do not require a separate heater to generate an electron beam current, so they consume less power. They can be turned on and off instantly in comparison with filament cathodes. They can also be made very small, so as to be used in miniature X-ray sources for radiation therapy, for example. U.S. Pat. Nos. 5,854,822 and 6,477,233 disclose examples of miniature cold cathode X-ray tubes. U.S. Pat. Nos. 6,760,407 and 6,876,724 disclose examples of larger X-ray tubes using cold cathodes for other purposes, such as imaging. Several types of field emission cold cathodes have been developed which can be substituted for the single hot filament cathodes. These include arrays of semiconductor or metal micro tips, flat cathodes of low work function materials and arrays of carbon or other nanotubes. While they offer several improvements, these cold cathode X-ray tubes share the limitations of their hot filament tube predecessors in being essentially point sources of X-rays. U.S. Pat. No. 6,333,968 discloses a transmission cathode for X-ray production in which current from the cathode generates X-rays on a target opposite the cathode, the radiation then transmitting through the cathode. The single cathode covers substantially the entire exit area for the radiation. This limits the size of the radiation exit area to the size of the cathode, making this type of source essentially a point source of X-rays. It also limits the area of the anode to that of the cathode, making it difficult to produce more than small levels of X-ray flux owing to the difficulty of extracting heat from this small area. Another transmission cathode is disclosed in U.S. Pat. No. 7,469,040, for a pipe-like source in which the cathode surrounds an inner chamber through which can pass material to be irradiated.

Other developments employ a wide area cold cathode array opposite a thin-film X-ray target disposed on an exit window. Examples are disclosed in U.S. Pat. Nos. 6,477,233 and 6,674,837. In these X-ray sources, the wide-area or pixilated beam of electrons produces a wide-area or pixilated source of X-rays. Electrons striking the X-ray target produce X-radiation in all directions. As shown conceptually in FIG. 1B, if the target is made thin enough, a portion of the X-rays will exit the side of the target opposite the electron beam source and pass through the exit window. A limitation of this type of X-ray source is that the heat produced in this process can be difficult to manage. The thinner the target film, the more X-ray flux can pass through the exit side, but the less heat can be dissipated by the film. The heat must ultimately be dissipated through the exit window or other parts of the vacuum envelope. In doing so, thermal stresses will be produced which necessarily limit the power of the X-rays that can be generated in this manner.

More recently, an X-ray source had been disclosed in U.S. Pat. No. 7,447,298 having a thermionic or cold cathode array inside a vacuum enclosure, which can direct e-beam current to a thin film X-ray target disposed on an exit window located above the cathode array with reference to the direction of the e-bam and X-ray fluxes, or, with a second cathode array, to a wide area anode located below the first cathode array, the second cathode arrays and the exit window with the thin-film anode. This source will have the heat dissipation limitations as discussed above for the thin-film X-ray target. X-rays produced by the lower, “reflective” anode will be attenuated first by the cathode arrays and their support structures, and then the thin-film X-ray target, resulting in an inefficient system. The second anode, while it can be thicker and have higher heat dissipation capacity than a thin-film anode, is inside the vacuum enclosure. The heat must therefore be transferred through the vacuum enclosure, which will limit the electrical and radiative flux power that can be achieved with this source.

X-ray treatment can be used to decontaminate biological or chemical agents. Chemical and gas methods for the remediation of hazards such as anthrax, ricin, or smallpox suffer a number of limitations, including hazards to human operators during their application, lingering hazards after they have been applied, limited effectiveness, long set-up and application times and destruction of electronic and other equipment in the treatment area. X-rays can decontaminate biological and chemical hazards through ionization, thereby decontaminating biohazards in a matter of minutes or hours, compared to days and weeks with chemical and gas methods. X-rays have the further advantage of being able to penetrate objects or surfaces which may occlude hazardous material. However, point sources of X-rays have limited heat dissipation capacity and therefore will be limited in their ability to cover a large decontamination or sterilization area. Sources of X-ray flux are needed which are broad, power efficient and can cover wide areas which may have been contaminated.

Other uses of X-rays include industrial, security and medical imaging. In some imaging applications there is a need for a collimated source of X-ray flux to cover a wide area. Current point sources of X-rays, however, must place the source at a considerable distance from the imaging object, thereby increasing the bulk of the imaging system, or rely on grazing incidence optical systems to spread and collimate the flux. Examples of such an optical system for an X-ray point source are the “Kumakhov lens” taught in U.S. Pat. No. 5,175,755 and the X-ray collimator taught in U.S. Pat. No. 6,049,588. These optical systems for point sources of X-rays, however, are bulky, complicated and expensive. Accordingly there is a need for a wide, flat source of collimated X-ray flux.

Current tomographic imaging systems using a single or dual X-ray tube source rely on complex and expensive mechanical gantries to move the tube into position for each of a succession of flux emissions. Several inventions have been made which use cold cathodes to make a multiplicity of X-ray spots for tomographic imaging, the general advantage being the ability to electronically address the X-ray spots, or X-ray pixels, at high speeds compared to the movement of a tube with a mechanical gantry. Some of these inventions use miniature X-ray tubes using a cold cathode electron source, for example U.S. Pat. No. 7,330,533. These, however can not be placed close enough together to enable fine pitch resolution for imaging. They are also limited in the X-ray flux which can be produced owing to difficulty of dissipating heat from their small anode. Other inventions have been made which arrange a multiplicity of cold cathodes inside a vacuum enclosure to generate X-rays from common anode. U.S. Pat. No. 6,553,096 and USU Patent Application 2007/0053489 teach an X-ray source with multiple carbon nanotube cold cathodes are arranged inside a source, with multiple angled anode targets also arranged inside the source, the flux from each of these X-ray pixels exiting the source in an area not occupied by the cathodes. These configurations will also be limited in the pixel pitch which can be obtained. Accordingly, there exists a need for a wide source of pixilated x-ray flux which can obtain fine pixel resolution.

### BRIEF SUMMARY OF THE INVENTION

Embodiments of the present disclosure are directed to systems and methods that are further described in the following description and claims. Advantages and features of embodiments of the present disclosure may become apparent from the description, accompanying drawings and claims.

According to one embodiment of the present disclosure an apparatus and method for the X-ray irradiation of materials. This apparatus includes an irradiation chamber, a number of flat electromagnetic (X-ray) sources, a support mechanism, a heat transfer system, and a shielding system. A shielded portal within the shielding system allows access to an interior volume of the irradiation chamber. The shielded portal allows materials to be placed in and withdrawn from the irradiation chamber. When closed, the shielded portal allows a continuous shielded boundary of the interior volume of the irradiation chamber. The electromagnetic sources are positioned on or embedded with interior surfaces of the irradiation chamber. These electromagnetic sources may generate an electromagnetic flux, such as an X-ray flux, where this flux is used to irradiate the interior volume of the irradiation chamber and any materials placed therein. The materials placed within the interior of the chamber may be supported by a low attenuation support mechanism. This low attenuation support mechanism does not substantially reduce the X-ray flux intended to irradiate the materials placed within the interior volume of the irradiation chamber. Additionally the irradiation chamber may have a heat transfer system thermally coupled to the irradiation chamber and electromagnetic sources in order to remove heat from the interior surfaces of the irradiation chamber. The shielding system external to the irradiation chamber prevents unwanted radiation from escaping from within the irradiation chamber.

Another embodiment of the present disclosure provides a method for the X-ray irradiation of materials. This method involves transporting a work piece or material to be irradiated to an irradiation chamber. The work piece or materials are placed within the irradiation chamber and supported with a mechanism such as a low attenuation support mechanism. This low attenuation support mechanism does not substantially reduce the electromagnetic flux (X-ray) flux within the irradiation chamber. One or more flat electromagnetic (X-ray) sources may be energized to irradiate the interior volume of the irradiation chamber. This allows the work piece or materials to be irradiated within the chamber. Excess heat may be removed with a heat transfer system in order to prevent the irradiation chamber/electromagnetic source from overheating. Additionally the irradiation chamber may be shielded to prevent the irradiation of objects and materials external to the irradiation chamber.

Yet another embodiment of the present disclosure provides another system for the X-ray irradiation of materials. This system includes an irradiation chamber, a number of flat X-ray sources, a transport mechanism, a low attenuation support mechanism, a heat transfer system, a shielding system, and a process controller. The irradiation chamber has an inner volume wherein the flat X-ray sources are positioned within or on the interior surfaces of the irradiation chamber such that the flat X-ray sources may irradiate the interior volume of the irradiation chamber. The transport mechanism allows materials to travel to and from the irradiation chamber. Within the irradiation chamber the low attenuation support mechanism supports the work pieces or materials to be irradiated while not substantially reducing the X-ray flux available for the irradiation of these objects. The heat transfer system removes heat from the X-ray source and the shielding system external to the irradiation chamber prevents inadvertent irradiation of materials and objects outside the irradiation chamber. The process controller coordinates the operation of the irradiation chamber, X-ray source, heat transfer system and an interlock system which prevents irradiation while access to the interior volume is open.

### BRIEF DESCRIPTION OF THE SEVERAL VIEWS OF THE DRAWINGS

For a more complete understanding of the present disclosure and the advantages thereof, reference is now made to the following description taken in conjunction with the accompanying drawings in which like reference numerals indicate like features and wherein:

FIG. 1A shows the directing of an electron beam current at an X-ray anode so as to produce X-rays at an angle to the current beam, the X-rays then exiting a window which is separate from the electron beam source;

FIG. 1B shows the directing of an electron beam current at thin-film X-ray anode disposed on the exit window so as to produce X-rays which then exit the window in a direction opposite from the electron beam source;

FIG. 1C shows the directing of an electron beam current from a cathode array formed on an exit window at an X-ray anode so as to produce X-rays which then pass by or through the cathodes as the X-rays exit the window in accordance with embodiments of the preset disclosure;

FIG. 2 depicts an X-ray flat panel source in which X-rays are produced in the manner depicted in FIG. 1C in accordance with embodiments of the preset disclosure;

FIG. 3 provides a diagram of an irradiation chamber in accordance with embodiments of the present disclosure;

FIG. 4 depicts a tiled arrangement 700 of x-ray panels in accordance with embodiments of the present disclosure;

FIG. 5 shows a typical x-ray source in a point source geometry in accordance with embodiments of the present disclosure;

FIG. 6 shows the large area flat panel x-ray source with a matrix addressed electron beam source and a vacuum assembly in accordance with embodiments of the present disclosure;

FIG. 7 shows a digitally addressed x-ray source where externally fabricated high current, high density cold cathode electron sources are placed at desired locations on the substrates in accordance with embodiments of the present disclosure;

FIGS. 8A and 8B shows a digitally addressed x-ray source where electron beams are focused at a desired location using focusing electrode structures which are assembled as part of the vacuum assembly in accordance with embodiments of the present disclosure;

FIGS. 9A and 9B illustrates the application of the digitally addressed x-ray source in breast tomosynthesis system with a source to detector distance of 60 mm and 30 mm in accordance with embodiments of the present disclosure.

FIG. 10 illustrates the application tiled DAXS panels in a small animal imaging system in accordance with embodiments of the present disclosure; and

FIG. 11 provides a logic flow diagram of a method of irradiating materials in accordance with embodiments of the present disclosure.

### DETAILED DESCRIPTION OF THE INVENTION

Preferred embodiments of the present disclosure are illustrated in the FIGs., like numerals being used to refer to like and corresponding parts of the various drawings.

The present disclosure relates to matrix addressed flat panel x-ray sources for use in applications where location specific addressing of x-ray beams is desired.

A conventional x-ray tube includes an anode, grid, and cathode assembly. The cathode assembly generates an electron beam which is directed to a target, by an applied electric field established by the anode. The target in turn emits x-ray radiation in response to the incident electron beam.

In high current x-ray tubes such as those used in tomographic imaging and radiography, high current and small spot size are desirable while operating at a high anode voltage. For these applications, electron beam current of tens of milliamps to several hundred milliamps is focused onto a small spot to generate a high intensity x-ray beam. To improve conduction of heat away from the anode, the anode plate is rotated at a high speed. In the case of computed tomography (CT) systems, the x-ray source is mounted on specially designed mechanical gantries and rotated around the object to be imaged. Current generation computed tomography systems involve a rotating x-ray source and a detector assembly on the other side of the patient.

It is desirable to have a system where there are no moving parts. This will result in improved imaging and reduce the cost and complexity of the system. There have been a number of efforts to remove the mechanical movement and replace it with an x-ray source that does not move. For example, in U.S. Pat. No. 7,068,749, they describe a stationary CT system comprising an annular x ray source assembly with a number of x-ray sources spaced along the annular x ray source assembly. Stationary electron sources are located along the with an x-ray target all inside of a vacuum assembly and a radiation window at a pre-defined angular displacement from the respective stationary X ray target.

In U.S. Pat. No. 4,521,900, Rand describes a method for scanning system for producing electrons in a vacuum chamber and rapidly scanning the electron beam in a fashion similar to CRT tube. In this case, the thickness of the target window of the CRT screen is such that x-rays produced will come out of the thin CRT window. While this approach produces addressable x-rays with a desired profile, there are serious limitations on the application of the method for CT imaging.

So far, attempts to replace the huge, expensive and performance-limiting mechanical gantries with simpler x-ray devices have seen limited progress. The disclosure presents a method to produce x-rays at desired locations on a large format flat panel matrix.

The present disclosure provides an apparatus and method for the X-ray irradiation of materials. This apparatus includes an irradiation chamber, a number of flat electromagnetic (X-ray) sources, a support mechanism, a heat transfer system, and a shielding system. A shielded portal within the shielding system allows access to an interior volume of the irradiation chamber. The shielded portal allows materials to be placed in and withdrawn from the irradiation chamber. When closed, the shielded portal allows a continuous shielded boundary of the interior volume of the irradiation chamber. The electromagnetic sources are positioned on or embedded with interior surfaces of the irradiation chamber. These electromagnetic sources may generate an electromagnetic flux, such as an X-ray flux, where this flux is used to irradiate the interior volume of the irradiation chamber and any materials placed therein. The materials placed within the interior of the chamber may be supported by a low attenuation support mechanism. This low attenuation support mechanism does not substantially reduce the X-ray flux intended to irradiate the materials placed within the interior volume of the irradiation chamber. Additionally the irradiation chamber may have a heat transfer system thermally coupled to the irradiation chamber and electromagnetic sources in order to remove heat from the interior surfaces of the irradiation chamber. The shielding system external to the irradiation chamber prevents unwanted radiation from escaping from within the irradiation chamber.

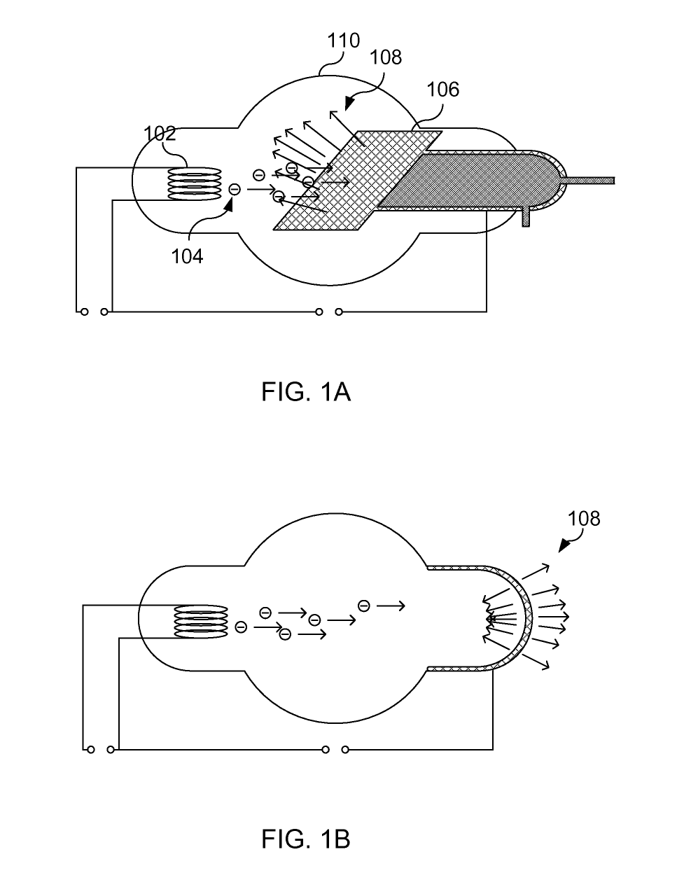

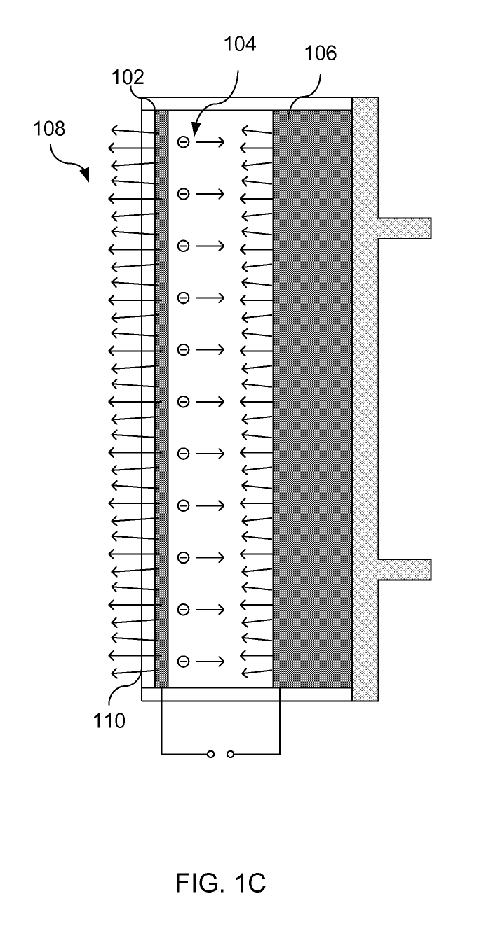

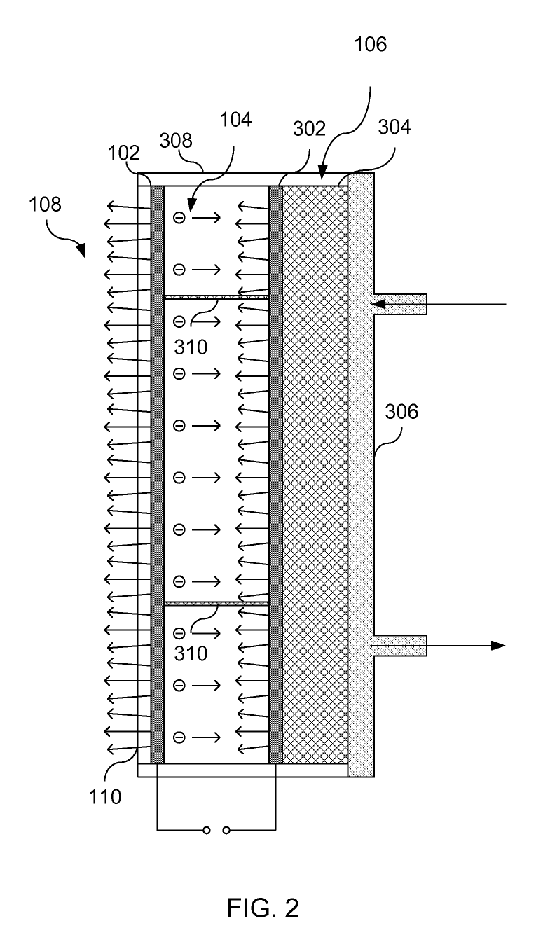

A general method of producing X-ray flux is shown in FIG. 1A. A cathode 102, commonly a hot filament cathode operated with an attached heater but more recently a field emission cold cathode, emits electron beam current 104. An electrical potential established with respect to metal anode 106 directs this current at high velocity across a vacuum to impact the anode, which is disposed at an angle to the normal direction of the electron beam current. The impact of beam current 104 on metal anode 106 produces X-ray flux, comprising both characteristic line radiation and Bremsstrahlung radiation, which is emitted in all directions. A portion 108 of the X-ray flux is emitted in the direction of exit window 110 and passes through the window. Cathode 102 and anode target 106 are enclosed in a vacuum tube or envelope which is commonly made of glass, ceramic or metal. X-ray flux which does not exit window 110 is absorbed in anode target 106, the vacuum envelope material, the exit window, or elsewhere in the source, this absorption process generating waste heat. Anode targets 106 have been made of many different elemental metals or alloys, the most common ones being tungsten, molybdenum, copper and tungsten-rhenium alloy. To reduce damage from electron beam impact and heating, anode 106 has been made as a disk with a beveled edge to provide a target angled in relation to beam current 104. This disk is connected to a metal rotor which is spun as part of an induction motor by a stator external to the vacuum tube or envelope. The electrical potential between cathode 102 and anode 106 varies widely depending on the desired energy of X-ray flux 108, higher potential producing higher energy X-rays. The higher the X-ray energy, the more ability the flux has to penetrate objects. Potentials used in imaging applications commonly vary between 30 keV and 200 keV. Depending on the material composition of anode target 106, different characteristic line energies, and amounts of characteristic line and Bremsstrahlung radiation, will be produced. Higher Z materials produce higher total amounts of radiation. The higher the electron beam current from cathode 102, the higher will be the X-ray flux generated at target 106 and therefore the X-ray flux 108 which exits the source. Exit windows 110 are commonly made of beryllium or other low Z materials with low coefficients of X-ray absorption, but they may be made of numerous other materials including various type of glass. In some prior art X-ray sources, the glass tube itself serves as the exit window. Numerous variations and combinations of these major elements of an X-ray source are well known.

FIG. 1B depicts another method that disposes a thin anode target layer 106 on exit window 110. A wide source of electron beam current 104 is produced by a wide area cathode 102 which impacts broadly over anode target layer 106. X-ray flux is generated in all directions from the anode target layer, a portion of the flux passing through the thin target layer and then the exit window as X-ray flux 108. The thinner the anode target layer, the more X-ray flux can pass through, but the less ability this layer will have to transfer waste heat. Flux output from this type of X-ray source must be limited to avoid thermal stresses, especially mismatches between target layer film 106 and exit window 110, which can cause delamination of the film from the window.

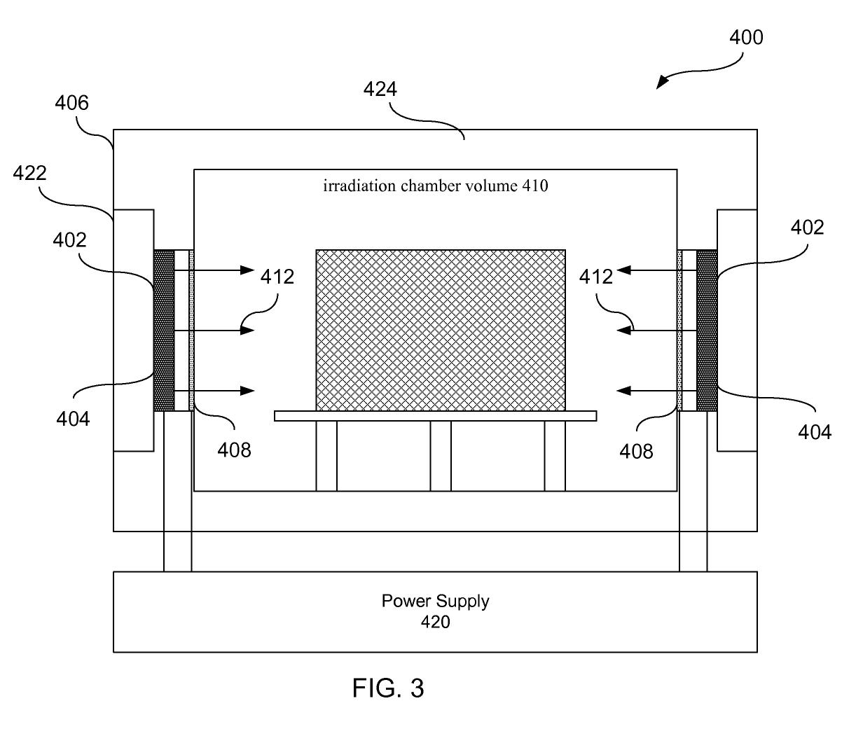

Embodiments of the present disclosure provide a different approach and method for the generation of X-rays. This is shown conceptually in FIG. 1C and in FIG. 2. FIG. 1C shows the directing of an electron beam current from a cathode array formed on an exit window at an X-ray anode so as to produce X-rays which then pass by or through the cathodes as the X-rays exit the window in accordance with embodiments of the preset disclosure. In these embodiments cathode array 102 maybe formed on the exit window itself. Cathode array 102 may be an array of field emission cold cathodes. Beam current 104 is emitted from cathode array 102 to impact anode target 106, disposed opposite or adjacent to exit window 110.

Anode target 106 may be a continuous sheet or slab of an X-ray target metal such as copper, tungsten or a tungsten-copper alloy. As shown in FIG. 2, anode target 106 may also be comprised of a film 302 of higher Z material, such as tungsten, attached to a sheet or slab 304 of material such as copper, chosen for lower cost, ease of working or superior heat dispersion characteristics. Film 302 may be bonded to sheet or slab 304 by sputtering or electroplating the material for film 302, by mechanically pressing film 302 on to sheet or slab 304 or by any other means which provides for the efficient conduction of heat from film 302 to sheet or slab 304. Film 302 may be a continuous thin film or it may be a film of discrete metallic particles. No matter how comprised, the other side of anode target 106 from cathode array 102 may be exposed directly to the outside atmosphere, in which case target 106 forms part of the vacuum envelope needed for operation of the radiation source. Further heat sinking structures 306 such as cooling fins, fans or forced liquid cooling channels may be provided on the atmosphere side of anode target 106 to allow operation of the source at very high power levels. Anode target 106 may be made flat to provide a broad area source of X-ray flux or it may be curved to provide focusing of the flux out of what is then an exit window 110 with smaller area than target 106. To produce X-ray flux from both sides of the source, target film 302 may be deposited on a sheet of material transmits a high degree of X-ray flux, though this embodiment will share some limitations of the prior art method shown in FIG. 1B.

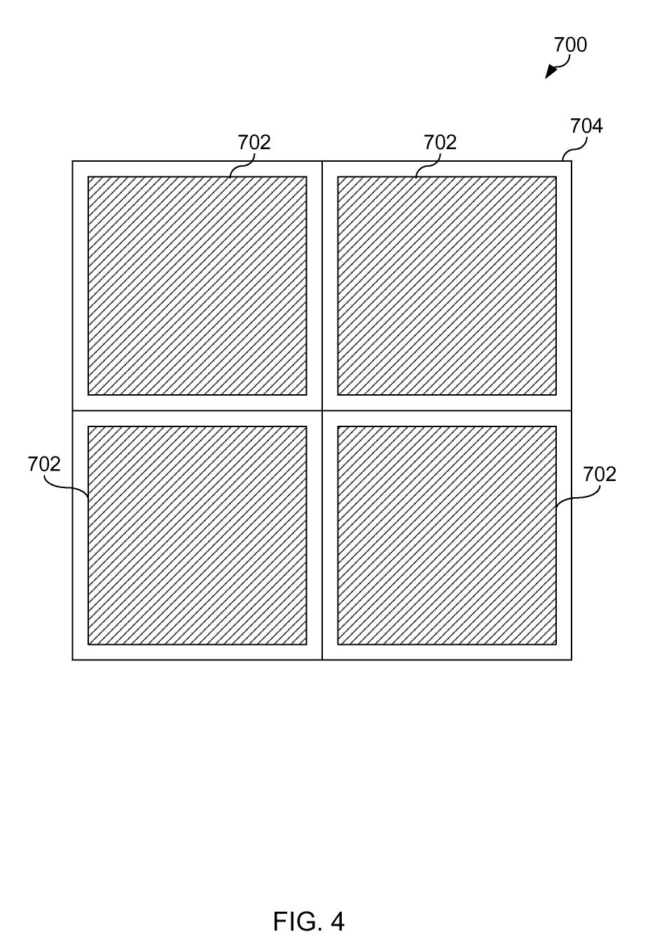

Upon impacting anode target 106 in FIGS. 1C and 2, beam current 104 will generate X-ray flux in all directions. A portion 108 of this flux will be emitted in the direction of beam current 104 and out exit window 110. It is desirable to minimize the amount of X-ray flux absorbed by exit window 110 and cathode array 102 and the waste heat generated thereby. Exit window 110 may therefore be chosen of a material compatible with vacuum sealing that has a low Z number. Table 1, which is presented in FIG. 3A shows some of the available Exemplary Exit Window Choices. The values in the “X-pray Properties” columns were generated using the PENELOPE software code produced by Oak Ridge National Laboratories. Exit windows made of beryllium (Z=4) provide the highest fractional transmission of X-ray flux and have a high degree of mechanical strength, making them a good choice for a vacuum envelope, but they also have drawbacks due to the cost and toxicity of the material. Various plastics may also be used for the exit window, provided that they have high mechanical strength and do not outgas to such an extent as to lower the vacuum inside the envelope and increase the risk of arcing or other vacuum breakdown. Plastics may be mechanically reinforced and passivated on the vacuum side with, for example, thin layers of oxides so as to increase their compatibility with vacuum operation. Various forms of glass also have reasonably good X-ray transmission characteristics, are relatively inexpensive and are available in large sheets suitable for the formation of various types of wide cathode arrays. Sapphire is another viable choice for the exit windows.

The absorption of X-ray flux by cathode array 102 can be minimized in two ways. First, the cathode array can be made of thin-film field emission cold cathodes. As shown in Table 1, cathodes made of graphite or other forms of carbon, which can be made in thicknesses of under a micron, will absorb very little of the X-ray flux. Second, cathode array can be distributed over exit window 110 so as to occupy very little of the area of the exit window. An exemplary share of the cathode area to the total exit window area is under 10 percent.

FIG. 2 also shows a portion of side wall 308, an essential component of the vacuum envelope. Side wall 308 is preferably made of an insulating material such as glass, alumina or other insulating ceramics such as Macor™. Side wall 308, exit window 110 and anode target 106 may be formed and joined in many different formats to provide radiation sources suitable for a variety of purposes. Cylindrical tubes of insulating material may be joined to circular exit windows and anode targets to form the vacuum envelope. Tubes of glass or ceramic are commonly available with diameters ranging from under two centimeters to over twenty centimeters. The side walls may also be formed as rectangles by joining together strips of insulating material. Exit windows and anode targets made in corresponding rectangular formats are then joined to the top and bottom, respectively, of the side walls to form the vacuum envelope. Radiation sources thus constructed may be made very wide. A number of techniques are available from the flat panel display industry that can be used to form cathode arrays over wide sheets of glass. Rectangular glass sheets of up to two meters on a side are now used to produce displays. Sheets or slabs of anode target materials are available in similarly large sizes. It is thus possible to form radiation sources using the method of this disclosure with areas of several square meters or more.

The distance between cathode array 102 on exit window 110 and anode target 106 may be set according to the electrical potential used between cathode and anode. The distance should be sufficiently large to prevent arcing or other vacuum breakdown between cathode and anode at the chosen voltage. It should also be large enough to prevent external breakdown between conductive components such as feed throughs on the external side of the source. An exemplary distance for a 100 keV potential is 2-5 centimeters. The exit window may be provided in thicknesses of under one millimeter to several millimeters, while the anode target sheet or slab can be provided with a thickness of several centimeters. The overall thickness of the source can thus be made from a few centimeters to perhaps ten centimeters. The ratio of the width of the source to its thickness can therefore be made greater than 3:1 and up to 100:1, for an essentially flat radiation source. The wider the area, the more need there will be for internal mechanical support to prevent deflection or sagging of the exit window 110 and anode target 106. Spacers 310 of suitable insulating material such as ceramics may be used to provide such support. Internal walls may also be formed of glass or ceramic to provide such spacer support. In some embodiments of the disclosure, these internal walls can be arranged as a grid so as to allow the attachment of smaller exit windows in each grid opening, thereby creating a tiled exit window structure.

Side walls 308, exit window 110 and anode target 106 should be made and joined with materials having thermal coefficients of expansion (TCE) matched so as to prevent cracks in the vacuum envelope during X-ray production and consequent heat dissipation. An exemplary set of materials is a tungsten-copper alloy for the anode target, alumina for the side walls and sapphire for the exit window. The TCEs of these materials are very closely matched. They may be joined with frit glass sealing techniques common in the vacuum tube and flat panel display industries. Alternative sealing methods include O-ring seals of high-temperature materials such as Viton™ and mechanical clamping supports, vacuum-compatible epoxies or silica-based sealants. Non-evaporable getters may be affixed inside the radiation source disclosed in this disclosure so as to maintain vacuum throughout the operational lifetime of the source. Electrical and getter activation feed throughs may be provided through sidewalls 308, exit window 110 or anode target 106. Anode target 106 may also have external electrical connection. Vacuum evacuation of the source may be accomplished through vacuum pumping through a pinch-off tube or valve attached to the source, or the assembly may be sealed in vacuum.

Operation of the X-ray flux source shown in FIG. 2 with cathode array 102 disposed directly opposite anode target 106 will improve the efficiency of X-ray generation and reduce power requirements for a given level of X-ray flux 108.

A variety of cathodes can be used in the cathode array for the radiation source according to the disclosure. Thin-film hot filament cathodes can be used, with internal or external heaters. The preferred cathodes, however, are thin-film, field-emission cold cathodes. The wide variety of cold cathodes known in the art can be used in this disclosure, including metal or semiconductor tip arrays, flat cathodes of low-work-function materials, metal-insulator-metal cathodes, surface conduction emission cathodes, vertical or horizontal arrays of carbon nanotubes, or field emitters with conductive chunks embedded in an insulating medium. A preferred cold cathode is the thin-film edge emitter. In these cathodes, field emission is from the external edges of a conductive thin film, which can be made of metal, various forms of carbon, or a carbon layer with upper and lower metal cladding layers to enhance conduction. Thin-film edge emitters made of arc-deposited carbon, pulsed arc deposited carbon, plasma arc deposited carbon, CVD diamond, laser ablated carbon or filtered arc deposited carbon are all suitable for use as cathodes in the disclosure. These cathodes can be made as continuous strips, as broken segments connected by conductive metal, or as separate cathode structures. Thin-film carbon cold cathodes are very thin, ranging in thickness from under a hundred Angstroms to a few thousand Angstroms. Metal conductive cladding can add several hundred more Angstroms to this thickness, but the resulting structure will still be so thin as to allow the transmission of essentially all the X-ray flux that reaches the cathodes. The cathodes are formed as arrays. In an exemplary design with an exit window of 100 cm², an array of 10,000 cathodes, each occupying about 2,500 μm², can supply all the current needed for the operation of a 500 Watt X-ray source at 100 keV.

The cathodes can also be gated so as to provide greater current control than would be possible in diode operation and radiation source control at lower voltages. Several gating schemes can be used. Separate transistors, such as field effect transistors, can be connected to individual cathodes or groups of cathodes. One method employs an extraction gate placed close to the cathode. In this embodiment, a gate voltage between 20 and 2,000V can be used to extract current from thin-film edge emitter cathode, the current then being captured by the field established by a higher voltage between cathode and anode. In operation, field emitters can sometimes emit debris due to micro discharges from the cathode or gate, or electromigration of material. It can therefore be advantageous to provide barriers to these material discharges so as to prevent cathode to gate shorts. These barriers can be made of deposited material or etched into exit window 110. Small pads for the cathodes and gates can also be made by depositing material or etching material from the window. These pads provide clearance for field lines between cathode and gate. They also allow the height of the gate to be raised in relation to the height of the cathode, which in turn provides control of the angle at which the electron beam current is emitted from the cathodes.

In a high voltage system such as the radiation source according to the present disclosure, it can be advantageous use a resistor to improve emission uniformity across a cathode array, suppress emitter to extractor arcs, and to act as current limiters for any emitter to extractor shorts. The line width, length and thickness can be varied to provide appropriate resistive values for cathodes operating under different conditions.

Cathodes and gates can be matrix addressed so as to provide small radiative emission spots, or pixels, from corresponding X-ray or UV-C targets across from the cathodes. Individual cathodes can be addressed so as to provide single spots or groups of cathodes can be addressed to provide emission patterns. This ability to precisely control radiative flux profiles over wide areas is useful for a number of imaging and scientific applications.

A further embodiment of the radiation source according to the present disclosure is the provision of circuitry to step up the voltage from the external power supply to the cathode and anode. This allows the use of more compact power sources and much thinner power cables to the radiation source. It also improves safety by lowering the risk of high voltage arcs external to the radiation source and makes the source itself more compact by allowing the use of smaller feed throughs. A number of voltage multiplication techniques well established in the prior art may be used in the radiation source according to the present disclosure. An exemplary technique is the Cockroft-Walton Amplifier (CWA), first developed in 1932 for high energy physics experiments and later used in nearly all black and white and many early color television sets.

The operating principle is very simple, and is based on the doubling of a pulsed input voltage by laddered diode-capacitor stages. The amplifier can be tapped at any stage to extract various voltages, as in a tapped transformer. A CWA supplying 100 keV and 5 mA, for example, may be made with twenty multiplier stages and a 3 kV input to the first stage. An external CWA or other step-up voltage amplifier may be used with the radiation source of this disclosure. In a novel and preferred embodiment of this disclosure, the CWA or other voltage amplification circuitry is disposed inside a vacuum envelope to take advantage of the superior insulation properties of vacuum. This can include forming the circuitry on the exit window of a single window source made according to the disclosure, or one of the exit windows in a source with tiled exit windows, on an interior wall of a compartmented source or on a separate insulating substrate affixed to part of the interior of the source, or in a separate compartment made to be part of the source.

For applications requiring collimated X-rays, such as X-ray lithography, a further embodiment of the disclosure provides X-ray focusing or collimating optics made as part of the radiation source. A number of X-ray mirrors or focusing schemes known in the art for point sources of X-rays may be incorporated as part of the radiation source according to the disclosure. A “Kumakhov lens”, for example is a glass tube, capillary or array of capillaries with internally curved surfaces which reflect diffuse incoming X-ray flux in such as way as to collimate the flux exiting the lens. In its application according to the present disclosure, arrays of small Kumakhov lenses may be formed as part of the exit window, or on a separate substrate placed in front of the exit window facing the X-ray target, or outside the window and attached to it. Arrays of Kumakhov lenses or other X-ray focusing lenses may be made etching the substrates or by forming sacrificial pillars in the profile of the focusing optics around which the window or other substrate may be formed by melting or spin-on glass processes, with the pillars then etched away using chemical processes. These lens arrays may be made as wide as an X-ray source made according to the disclosure, thereby providing wide sources of collimated X-rays.

Separate or combined sources of X-ray and UV-C flux made according to the disclosure may be used to sterilize materials or to decontaminate biological or chemical hazards. In decontamination applications, these radiation sources may be combined into systems with the individual sources positioned so as to allow the broadest and most effective coverage of a contaminated area. In an office environment. For example, the sources may be arranged at three levels, each having three or more sources to provide 360° coverage of the area. One tier may be at ankle height so the flux can reach contaminants under tables or desks and on the floor. The next tier may be at waist height so the flux can reach contaminants which have settled on desks or tables, while the third tier may be at shoulder height so the flux can reach contaminants which have settled on cabinets and other tall objects. The sources may also be rotated to provide 360° coverage or mounted on robots with radiation shielded electronics and moved around the contaminated space.

FIG. 3 provides a diagram of an irradiation chamber in accordance with embodiments of the present disclosure. Irradiation chamber 400 includes x-ray sources 402, outer side 406, irradiation chamber volume 410, support structure 416, anode surface 404, power supply 420, heat exchanger system 422 and shielding 424. X-ray sources 402 include an anode surface 404 and cathode surface 408. In the embodiment shown in FIG. 3, two flat x-ray sources 402 as discussed above are arranged on either side of the irradiation chamber 400. They are arranged such that the tungsten anode surface 404 is on the outer side 406 whereas the cathode surface 408 faces inwards towards the irradiation chamber volume 410. X-ray flux 412 passes through the cathode surface 408 and into the irradiation chamber volume 410. The irradiation chamber volume 410 holds the material 414 to be processed and is supported by support structure 416 made from low attenuation material such as carbon or Plexiglas so as to not attenuate the x-ray flux 412. Alternatively, a carousel can be provided to rotate the specimen 418 to be irradiated for uniform distribution of dose. The power supply 420 is a standard power supply placed at the bottom of the irradiation chamber and supplies power to both the x-ray panels. Heat exchanger system 422 is placed on the rear end with fans for cooling. The entire assembly is enclosed in shielding 424 such as a lead shield.

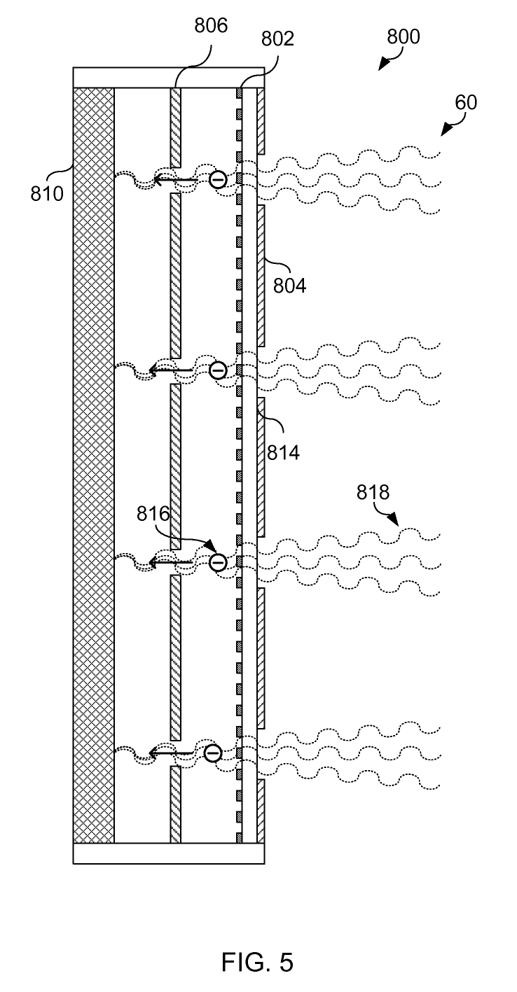

FIG. 4 depicts a tiled arrangement 700 of x-ray panels in accordance with embodiments of the present disclosure. In one embodiment, four 10″ panels 702 are tiled together using methods described in to form a larger 20″×20″ panel 704. Two such large panels may be placed on either side of the irradiation chamber 400. The panels can be digitally addressed by a control system via address lines and electronics to operate them individually or simultaneously.

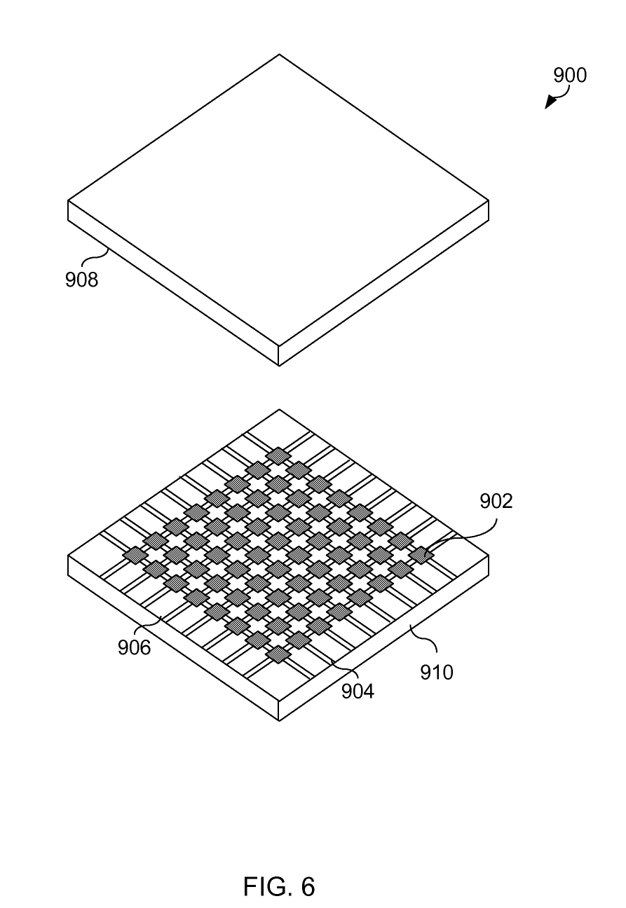

FIG. 5 shows a typical x-ray source in a point source geometry in accordance with embodiments of the present disclosure. This arrangement 800 uses a cold cathode array 802, external grid 804, internal grid 806 and anode 810. The shielding of the anode 810 by internal grid 806 allows the continuous anode to act as an array of point sources 812.

Such as source may be formed as follows. First cold cathode emitter array 802 is fabricated on flat substrate 814 such as glass, quartz or sapphire. The cold cathode emitters are fabricated to enable matrix addressing using external drive circuits. Unlike other cold cathode applications such as field emission displays, with digitally addressed x-ray panels, the emission current density required is extremely high, but it is confined to active areas of 1 mm or less. For most computed tomography applications, desired currents are in the 1 to 500 mA range.

The high-density emitter arrays are fabricated first in the desired configuration where emitters are aggregated to provide the desired pixilation. Electron sources 802 may be arranged in a (x, y) matrix with the periodicity determined by the application. Typically, each pixel is capable of generating electron beam 816 having a current of 1 to 500 mA within an active area of generally smaller than a 1 mm.

Emitter substrate and the tungsten anode 810 are assembled within a sealed vacuum envelop. Electrons 816 are emitted from the matrix addressed emitter array 802 according to the pixel being addressed. A high potential is applied between the emitter array and the anode 810. The pixilated electron beam 816 accelerates towards the anode 810, electron impact results in the production of X-rays 818 production. The x-rays 818 thus produced are pixilated or in other words the beam characteristics are defined by the electron source array. The X-ray beam is transmitted through the transparent cathode 802 and substrate 814 towards the object to be imaged or studied.

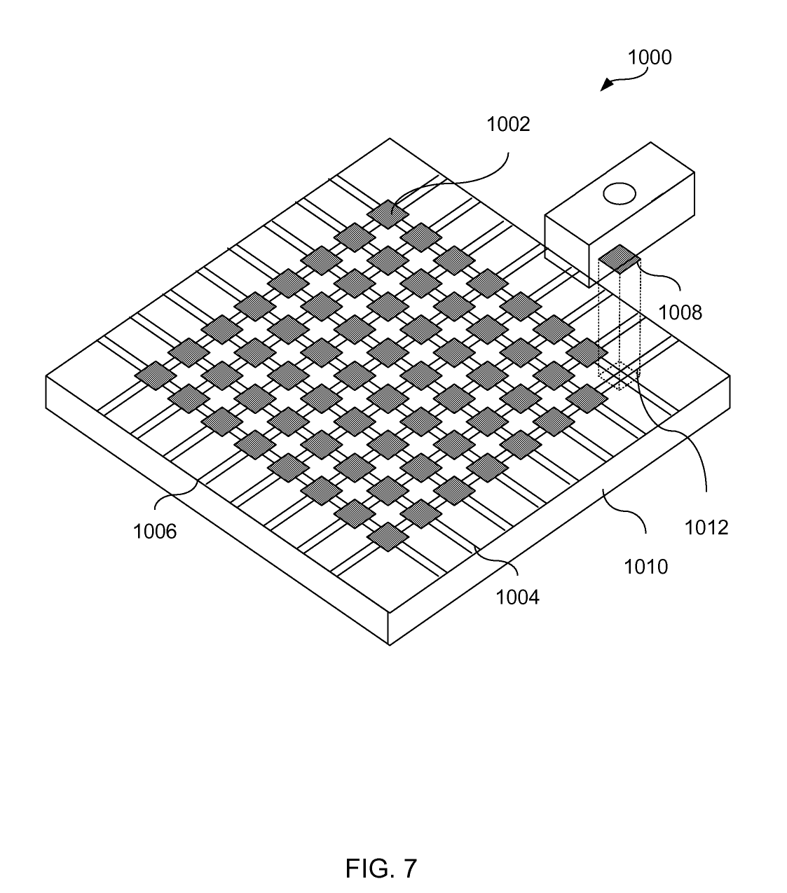

FIG. 6 shows a typical x-ray source 900 in a point source geometry having individual addressable emitters 902 in accordance with embodiments of the present disclosure. X-ray source 900 includes individual addressable emitters 902, row and column addressing elements 904 and 906, anode 908 and substrate 910. Individual addressable emitters 902 may be fabricated using microelectronic fabrication processes. In one instance, an emitter array may be fabricated on large flat panel glass substrate 910, the resolution of the photolithography tools sometimes limit the size of the individual emitters to large dimensions. Also, it is not always advantageous to fabricate devices on large substrates directly, as this limits operational performance of devices due to the poor high voltage stability of low temperature interlayer dielectrics.

In another embodiment, high-density field emitter arrays may be fabricated on substrates of single crystal wafers such as silicon. This also allows one to build more robust devices with a variety of materials and dielectrics with a higher dielectric breakdown. Also, fabrication on silicon wafers allows one to fabricate devices with micron and submicron feature sizes, and emitters that can operate at voltages much less than 100V. This leads to increased emitter density to well beyond 10,000 emitters within a square millimeter area. This approach allows one to make devices on desired substrates and test the arrays and locate the arrays with optimum operating characteristics on a different substrate.

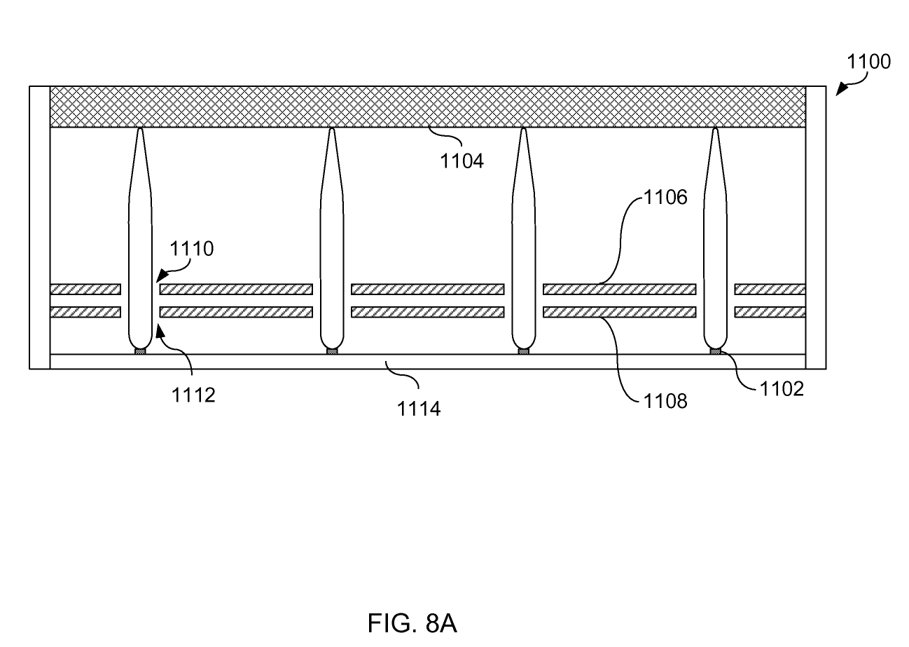

FIG. 7 shows a typical x-ray source 1000 in a point source geometry having individual addressable emitters 1002 in accordance with embodiments of the present disclosure. X-ray source 1000 includes individual addressable emitters 1002, row and column addressing elements 1004 and 1006, and substrate 1010. The wafer is thinned to desired thickness and the known good die 1008 (KGD) are then isolated. The KGD devices are cut to desired dimensions, then bonded to the glass panel 1010 at desired locations 1012 on the (x, y) matrix as illustrated in FIG. 7. The devices are then connected to the outside using wire bonding or other interconnect methods. In the case, where KGD die are attached to a glass substrate, the underlying surface of the glass substrate is coated with a thin layer of a conductive film or conductive traces 1004 and 1006. Desired materials for the conductive film include tungsten, tantalum, or any other material with high thermal and electrical conductivity. The x-ray transmission through the film is a critical parameter and thickness of the film is limited to less than 10 um.

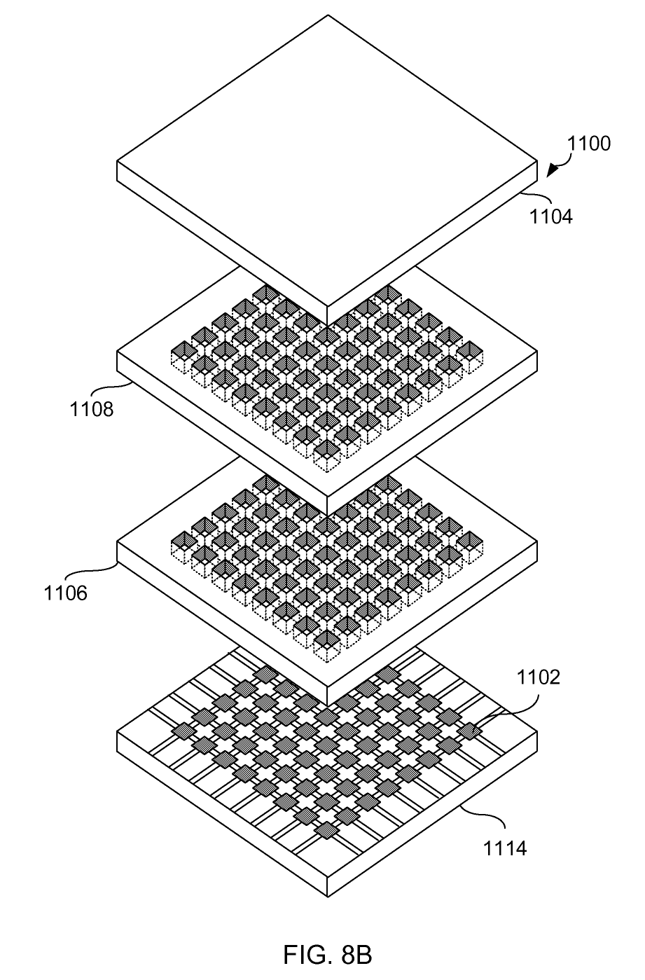

FIGS. 8A and 8B show a typical x-ray source 1100 in a point source geometry having individual focusable emitters 1102 in accordance with embodiments of the present disclosure. X-ray source 1100 includes individual emitters 1102, anode 1104, focusing electrode structures 1106 and 1108, and substrate 1114. This approach may increase emission current density on the target/anode by using electron optics (focusing electrode structures 1106 and 1108) to focus emission from a large area on the cold cathode array into a small spot on the anode 1104. This is accomplished by placing suitable focusing electrode structures 1106 and 1108 having apertures 1110 and 1112 within the vacuum envelop between cold cathode array and the anode. The focusing electrodes 1106 and 1108 are made of metal sheets with apertures 1110 and 1112 located at desired locations and suitably aligned with a large addressable array of emitters 1102. For examples, with a high-density design, a large pixel array with 100,000 individual emitters can be used as a single pixel element. When appropriate potentials are applied on the electrodes, the electron beam from the large emitter array is focused on a desired spot size of 1 mm or less on the anode.

One of the important advantages of including an aperture array is to provide a conductive layer for bleed off charged particles that are generated during the electron impact process and by the impact of x-rays on various surfaces.

Another advantage of including apertures in the vacuum space between the cold cathode array and the anode is to provide collimation of the x-ray beam. The collimation of the x-ray beam from the anode.

Application of DAXS panels has several advantages in x-ray medical imaging. The resulting systems are compact, provide higher temporal resolution, and allows for configurations that do not require the x-ray source to be moved.

With digitally addressed x-ray sources, one can achieve rapid switching speeds. This is especially critical in cardiac CT imaging where the cardiac motion causes small objects in CT images to be blurred. Switching speeds of a microsecond makes fast acquisition of cardiac images possible.

Our method for the application of digital x-ray sources for digital breast tomosynthesis (DBT) and small animal CT (SACT) provides advantages in making these systems compact and allows for rapid image acquisition.

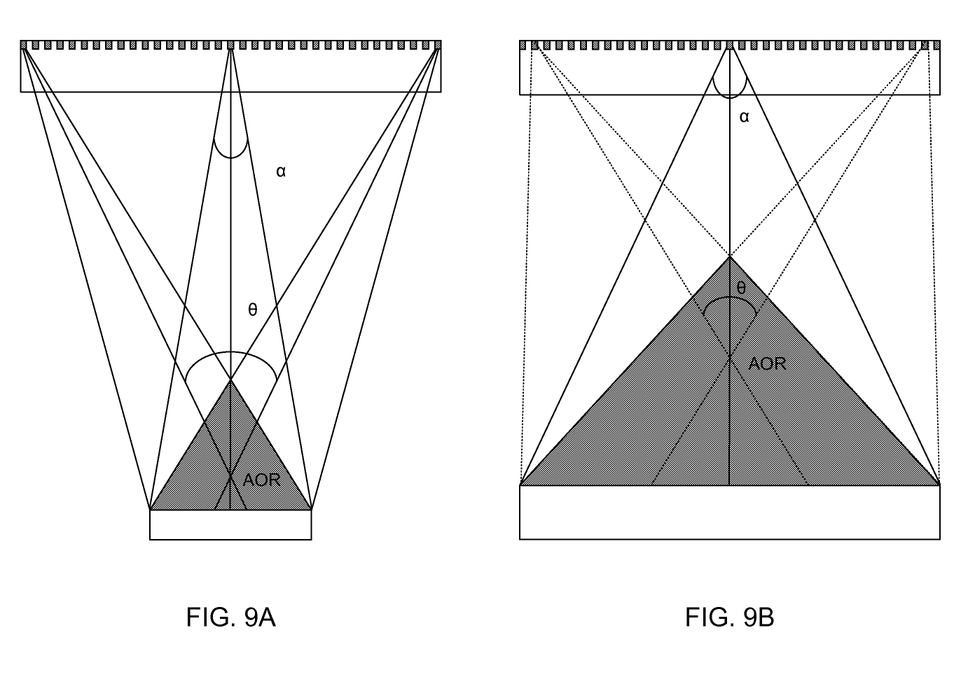

FIGS. 9A and 9B depict the application of DAXS to digital breast tomosynthesis (DBT) with two different source to detector distances in accordance with embodiments of the present disclosure. In existing DBT systems, this distance is normally 60 cm as shown in FIG. 9A. Using a DAXS panel, this distance can be reduced to 30 cm as shown in FIG. 9B. While the incorporation of DAXS leads to a compact assembly, the bigger impact is on lowering the total x-ray flux required to acquire an image. When compared to existing DBT system, which are limited by the heel effect, embodiments of the present disclosure can increase the beam angle to 53°.

In the case of small animal computed tomography (SACT), acquisition of useful images is a difficult task due to the high heart rate of small animals. For example, in the case of mice, the heart rate is as high as 600 beats per minute. In a CT system with a moving x-ray source, it is not possible to rapidly move the source through a whole half circle, which requires over 200 cross sections with each requiring 20 secs. With a DAXS based system, this issue can be solved by taking advantage of the rapid switching speed of DAXS panel.

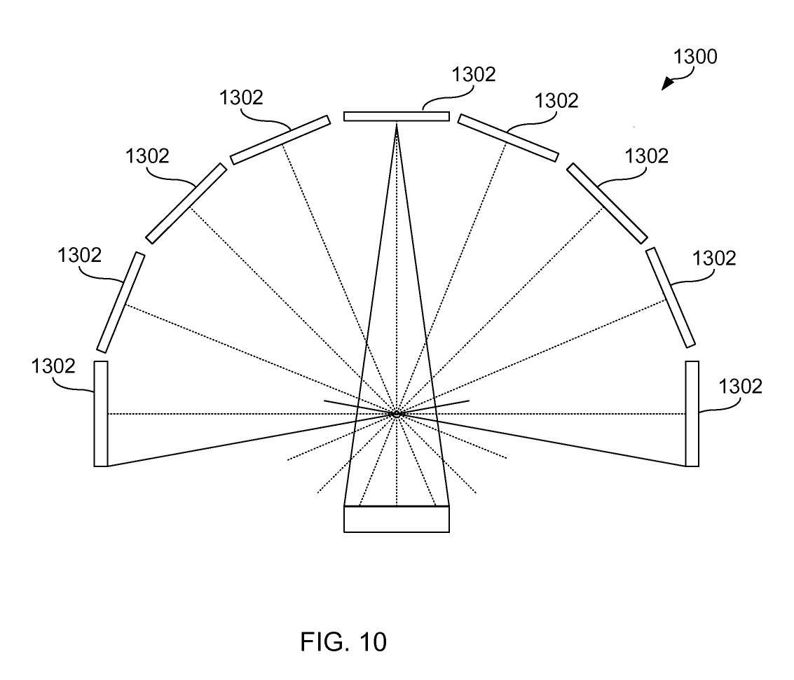

FIG. 10 provides a diagram of a SACT system 1300 with multiple DAXS panels 1302 tiled together with a source to detector distance of 36 cm with the source-axis of rotation (AOR) distance of 27.5 cm.

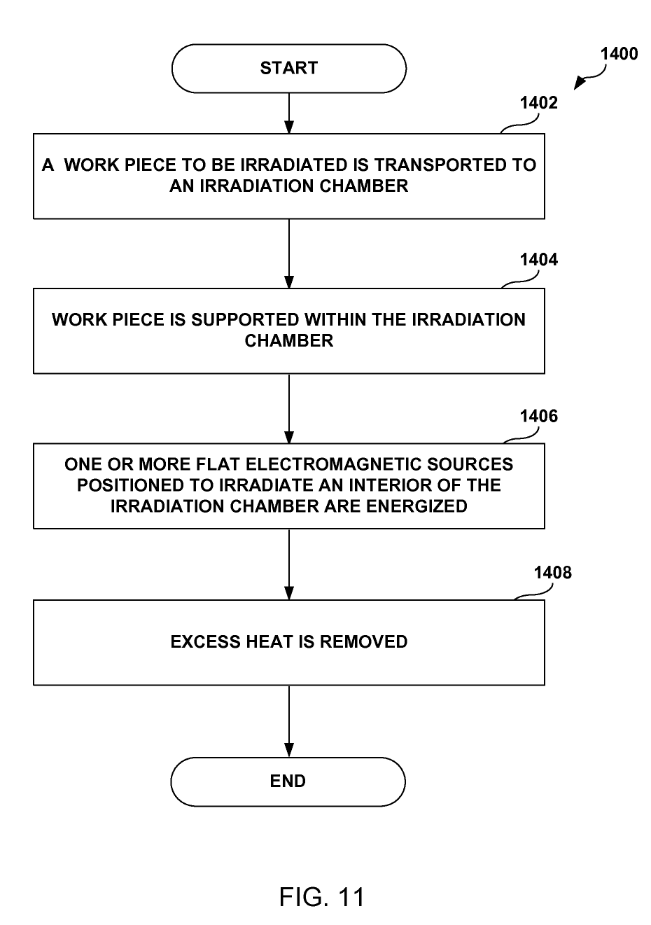

FIG. 11 provides a logic flow diagram of a method of irradiating materials in accordance with embodiments of the present disclosure. Operations 1400 begin with block 1402 where a work piece to be irradiated is transported to an irradiation chamber. This may involve placing materials directing within a chamber through a shielded portal that allows access as discussed previously, placing the materials on a conveyor, or pumping fluids through the chamber. A carousel within the irradiation chamber may be used to rotate the work piece within the irradiation chamber for uniform distribution of the electromagnetic flux to the work piece. In block 1404, the work piece is supported within the irradiation chamber with a low attenuation support mechanism. Then, in block 1406, one or more flat electromagnetic sources positioned to irradiate an interior of the irradiation chamber are energized at a controlled energy level and time. The electromagnetic (X-ray) sources have a number of addressable cathode emitters. The operation of the electromagnetic sources and the number of addressable cathode emitters is controlled by the process controller. Excess heat is removed from the one or more flat electromagnetic source with a heat transfer system in Block 1408. The exterior is shielded from the electromagnetic flux within the irradiation chamber by a shielding system. The electromagnetic flux comprising an X-ray flux or an ultraviolet flux. A process controller may be used to coordinates the operation of the irradiation chamber; one or more flat electromagnetic sources, the heat transfer system; and the interlock system.

In summary, the present disclosure provides an apparatus and method for the X-ray irradiation of materials. This apparatus includes an irradiation chamber, a number of flat electromagnetic (X-ray) sources having a number of addressable cathode emitters, a support mechanism, a heat transfer system, a shielding system, and a process controller. A shielded portal within the shielding system allows access to an interior volume of the irradiation chamber. The electromagnetic sources are positioned on or embedded within interior surfaces of the irradiation chamber. These electromagnetic sources generate an electromagnetic flux, such as an X-ray flux, where this flux is used to irradiate the interior volume of the irradiation chamber and any materials placed therein. The operation of the electromagnetic sources and the number of addressable cathode emitters is controlled by the process controller. The materials placed within the interior of the chamber may be supported by a low attenuation support mechanism. This low attenuation support mechanism does not substantially reduce the X-ray flux intended to irradiate the materials placed within the interior volume of the irradiation chamber. Additionally the irradiation chamber may have a heat transfer system thermally coupled to the irradiation chamber and electromagnetic sources in order to remove heat from the interior surfaces of the irradiation chamber. The shielding system external to the irradiation chamber prevents unwanted radiation from escaping from within the irradiation chamber.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A system comprising:
an irradiation chamber;
at least one flat electromagnetic source positioned to irradiate an interior of the irradiation chamber, the at least one flat electromagnetic source comprising:
a hermetically sealed volume;
a the large area cathode, the large area cathode having an array of individually addressable cathode emitters operable to emit electrons (e⁻), the large area cathode forming an outer surface of the hermetically sealed volume;
a large area anode, the anode within the hermetically sealed volume, the anode and cathode are substantially parallel, and the area of the cathode and the area of the anode are substantially equal;
the anode operable to generate an electromagnetic flux substantially normal to a large area surface of the anode in response to the e⁻'s impacting the anode;
the cathode substantially transparent to the electromagnetic flux, the electromagnetic flux exiting the hermetically sealed volume through the cathode and into the interior volume of the irradiation chamber.
a low attenuation support mechanism operable to support a work piece to be irradiated within the irradiation chamber;
a heat transfer system operable to remove heat from the at least one flat electromagnetic source;
a shielding system placed on the exterior surfaces of the irradiation chamber to prevent inadvertent irradiation outside of the irradiation chamber.

2. The system of claim 1, the at least one flat electromagnetic source further comprising:
at least one internal grid operable to collimate the emitted electrons.

3. The system of claim 1, the electromagnetic flux comprising an X-ray flux.

4. The system of claim 1, the at least one flat electromagnetic source further comprising:
at least one electron focusing structure operable to focus the emitted electrons at the anode.

5. The system of claim 1, the at least one flat electromagnetic source further comprising:
at least one external grid operable to collimate the electromagnetic flux.

6. The system of claim 1, further comprising a process controller operable to energize the individually addressable cathode emitters.

7. The system of claim 1, further comprising high voltage insulation between the irradiation chamber and the at least one flat electromagnetic source.

8. The system of claim 1, further comprising a process controller operable to coordinate the operation of:
the irradiation chamber;
the at least one flat electromagnetic source;
the heat transfer system; and
the interlock system.

9. The system of claim 8, wherein a plurality of flat electromagnetic source are tiled to irradiate the irradiation chamber, the process controller operable to energize the tiled flat electromagnetic sources individually or simultaneously.

10. The system of claim 8, wherein the individually addressable cathode emitters may be individually energized to irradiate the irradiation chamber, the process controller operable to energize the addressable elements individually or simultaneously.

11. A method comprising:
energizing at least one individually addressable cathode emitters within a flat electromagnetic source positioned to irradiate an interior of the irradiation chamber with an electromagnetic flux;
irradiating the work piece within the irradiation chamber
removing excess heat from the at least one flat electromagnetic source with a heat transfer system; and
shielding the exterior from the electromagnetic flux within the irradiation chamber.

12. The method of claim 11, the flat electromagnetic source comprising an array of individually addressable cathode emitters operable to emit electrons (e⁻) comprising a large area cathode, the large area cathode forming an outer surface of the hermetically sealed volume;

13. The method of claim 11, the electromagnetic flux comprising an X-ray flux.

14. The method of claim 11, further comprising focusing the emitted electrons with at least one electron focusing structure operable to focus the emitted electrons at the anode.

15. The method of claim 11, further comprising collimating the emitted electrons with an internal grid.

16. The method of claim 11, wherein a process controller operable to energize the individually addressable cathode emitters.

17. The method of claim 11, wherein a process controller operable to coordinates the operation of:
the irradiation chamber;
the at least one flat electromagnetic source;
the heat transfer system; and
the interlock system.

18. The method of claim 11, wherein a plurality of the individually addressable cathode emitters are energized individually or simultaneously.

19. The method of claim 11, wherein a plurality of flat electromagnetic sources is tiled to irradiate the irradiation chamber, the tiled flat electromagnetic sources individually or simultaneously.

20. A system comprising:
an irradiation chamber;
at least one electromagnetic source positioned to irradiate an interior of the irradiation chamber, the at least one electromagnetic source comprising:
a hermetically sealed volume;
a the large area cathode, the large area cathode having an array of individually addressable cathode emitters operable to emit electrons (e⁻), the large area cathode forming an outer surface of the hermetically sealed volume;
a large area anode, the anode within the hermetically sealed volume, the anode and cathode are substantially parallel, and the area of the cathode and the area of the anode are substantially equal;
the anode operable to generate an electromagnetic flux substantially normal to a large area surface of the anode in response to the e⁻'s impacting the anode;
the cathode substantially transparent to the electromagnetic flux, the electromagnetic flux exiting the hermetically sealed volume through the cathode and into the interior volume of the irradiation chamber.
a transport mechanism operable to transport a work piece to and from the irradiation chamber;
a low attenuation support mechanism operable to support a work piece to be irradiated within the irradiation chamber;
a heat transfer system operable to remove heat from the at least one flat electromagnetic source;
a shielding system placed on the exterior surfaces of the irradiation chamber to prevent inadvertent irradiation outside of the irradiation chamber; and
a process controller operable to coordinates the operation of:
the irradiation chamber;
the at least one flat electromagnetic source;
the array of individually addressable cathode emitters;
the heat transfer system; and
the interlock system.

21. The system of claim 20, the at least one electromagnetic source further comprising at least one internal grid operable to collimate the emitted electrons.

22. The system of claim 20, the at least one flat electromagnetic source further comprising at least one electron focusing structure operable to focus the emitted electrons at the anode.
